(19) United States
(12) Patent Application Publication
(10) Pub. No.: US 2012/0179501 A1
(43) Pub. Date: Jul. 12, 2012

(54) DECISION SUPPORT

(76) Inventors: Yolanta Beresnevichiene, Bristol (GB); Marco Casassa Mont, Bristol (GB); David Pym, Inverurie (GB); Simon Kai-Ying Shiu, Bristol (GB)

(21) Appl. No.: 12/986,676

(22) Filed: Jan. 7, 2011

(51) Int. Cl. G06Q 10/00

(52) U.S. Cl. 705/7.11

(57) ABSTRACT

Information relating to an entity's objectives is received, a utility function based on the received objectives is derived, the utility function is compared with results from a number of simulated investment options, and the comparisons are presented to a user associated with the entity.

### BACKGROUND

Members of organizations who are in charge of making important decisions must often balance different objectives. For example, a chief information security officer must make decisions regarding the protection of the organization's information technology assets while also meeting the organization's business objectives. It is often difficult for this decision maker to determine how well a particular investment into a particular security measure will correspond with the organization's other business goals and limitations. Various systems and standards are available to help decision makers make better informed decisions regarding security. Although these tools may be helpful, they are often difficult to customize with a particular organization's unique needs and limitations.

### BRIEF DESCRIPTION OF THE DRAWINGS

The accompanying drawings illustrate various examples of the principles described herein and are a part of the specification. The illustrated examples do not limit the scope of the claims.

FIG. 1 is a diagram showing an illustrative decision support system, according to one example of principles described herein.

FIG. 2 is a diagram showing illustrative components of a decision support system, according to one example of principles described herein.

FIG. 3 is a flowchart showing an illustrative process for decision support, according to one example of principles described herein.

FIGS. 4A and 4B are graphs showing a number of illustrative outcomes, according to one example of principles described herein.

FIGS. 5A-5C are diagrams showing the nature of target outcomes, according to one example of principles described herein.

FIG. 6 is a flowchart showing an illustrative method for decision support, according to one example of principles described herein.

Throughout the drawings, identical reference numbers designate similar, but not necessarily identical, elements.

### DETAILED DESCRIPTION

As mentioned above, decision makers within an organization must make decisions regarding the protection of the organization's information technology assets while also meeting the organization's business objectives. Often times, different decision makers within an organization will have conflicting objectives. For example, an operational manager needs to make sure that the organization's systems are operating as desired. Additionally, a security manager needs to take steps to minimize security breaches during the operations. Particular measures taken by one decision maker may have an adverse affect on the other decision maker's objectives. For example, a stricter security policy may result in slower operations.

Furthermore, it is often difficult for these decision makers to determine how well a particular investment into a particular security measure will correspond with the organization's other business goals and limitations. A security investment decision often affects multiple objectives and goals aside from a security objective. For example, a security investment decision may also affect an organization's performance and productivity objectives.

In light of this and other issues, the present specification discloses systems and methods for decision support that will allow a user to make better informed decisions relating to security investment decisions. According to certain illustrative examples, a decision support system prompts one or more users for information regarding an organization's objectives. These objectives may include business and other operational objectives as well as security objectives. The information received from the user is used to derive a utility function. Additionally, the decision support system simulates the implementation of a number of investments. The results of these simulations can then be used with the utility function to determine how well these potential investments may correspond with the organization's objectives.

Through use of systems and methods embodying principles described herein, decision makers within an organization may be better informed as to how various security investments will correspond to security and business objectives. For example, a chief information security officer may obtain better information about how a potential security measure will fit in with the organization's risk tolerance for security breaches as well as their economic ability to take on such measures. Furthermore, in cases where multiple decision makers with conflicting objectives are involved, the decision support system may help those decision makers determine which compromises will maximize utility.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example,” or similar language means that a particular feature, structure, or characteristic described in connection with the example is included in at least that one example, but not necessarily in other examples. The various instances of the phrase “in one example” or similar phrases in various places in the specification are not necessarily all referring to the same example.

Throughout this specification and in the appended claims, the term “investment” is used broadly and may encompass any effort made towards satisfying an objective. As such, an investment may involve but does not necessarily require financial capital. An example of an investment may be the acquisition of new hardware or the implementation of a new policy irrespective of whether such an acquisition of hardware or implementation of a policy requires a capital expenditure.

Throughout this specification and in the appended claims, the term “entity” is used broadly and may encompass both an individual or an organization.

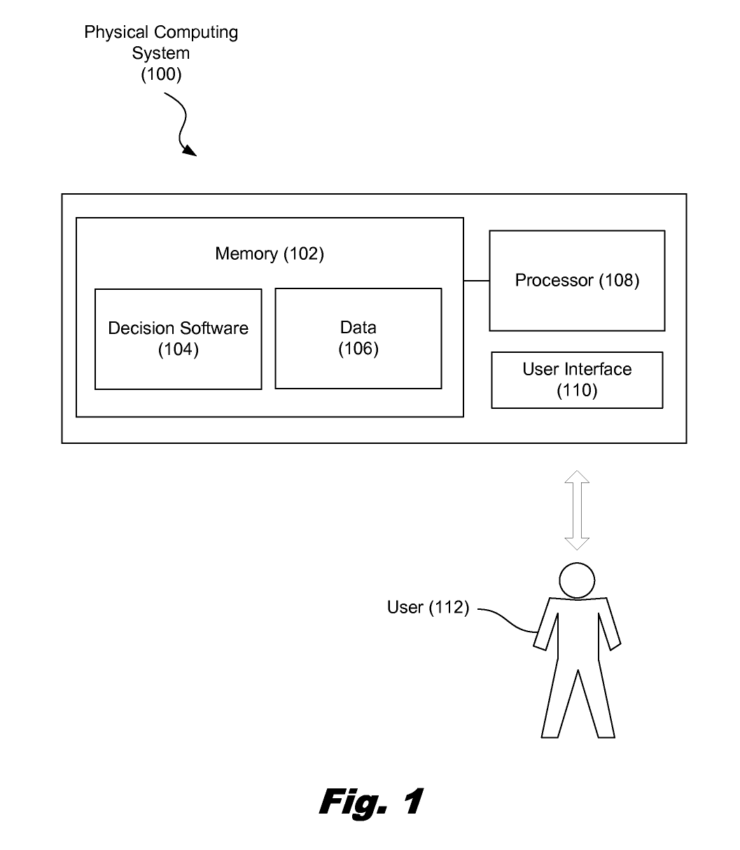

Referring now to the figures, FIG. 1 is a diagram showing an illustrative physical computing system (100) that can be used for decision support applications. According to certain illustrative examples, the physical computing system (100) includes a memory (102) having decision logic (104) (e.g., software composed of one or more different instructions) and data (106) stored thereon. The physical computing system (100) also includes a processor (108) and a user interface (110).

There are many types of memory available. Some types of memory, such as solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The physical computing system (100) also includes a processor (108) for executing the software (104) and using or updating the data (106) stored in memory (102). The software (104) may include an operating system. An operating system allows other applications to interact properly with the hardware of the mobile computing system. The other applications may include a decision support application.

A user interface (110) may provide a means for the user (112) to interact with the physical computing system (100). The user interface may include any collection of devices for interfacing with a human user (112). For example, the user interface (110) may include an input device such as a keyboard or mouse and an output device such as a monitor.

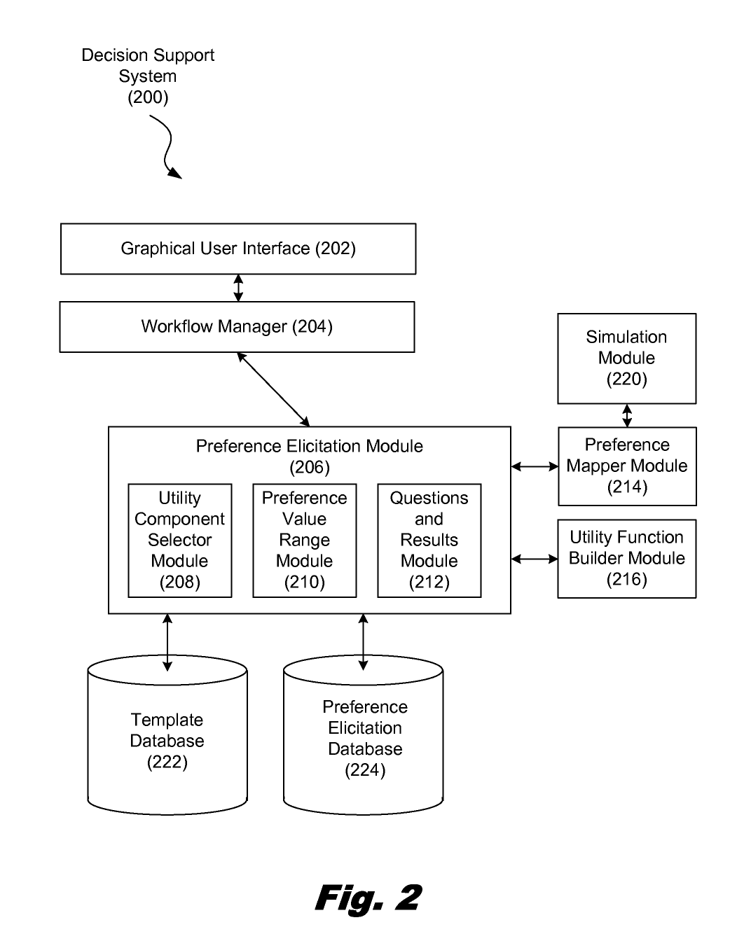

FIG. 2 is a diagram showing illustrative components of a decision support system. According to certain illustrative examples, the decision support system includes a graphical user interface (202), a workflow manager (204), a preference elicitation module (206), a simulation module (220), a preference mapper module (214), a utility function builder module (216), a template database (222) and a preference elicitation database (224).

The graphical user interface (202) provides the mechanism that allows a user such as a decision maker to interact with the decision support system (200). The graphical user interface (202) presents information to a user through a display device and receives information from the user from an input device. For example, the graphical user interface (202) may display to a user a number of questions relating to various business and security objectives. The user may respond to those questions through use of the input device.

The workflow manager (204) manages the flow of the decision support system (200). Specifically, the workflow manager (204) coordinates the use of the other modules, which will be described in more detail below. These modules allow the decision support system (200) to receive the desired information from the user, create a utility function, simulate investment options and present the best options back to the user through the graphical user interface (202). The workflow manager also manages situations where the preference elicitation is provided to multiple users. Each user may be accessing the decision support system remotely from individual client machines either concurrently or subsequently.

The preference elicitation module (206) includes the hardware and software for determining how to elicit information from a user. The preference elicitation module guides a user, such as a decision maker, through the elicitation process. This process may include one or more steps consisting of questionnaires and graph manipulation. The preference elicitation module (206) accesses a template database (222) for a set of questions to ask a user. The preference elicitation module includes a utility component selector module (208), a preference value range module (210), and a questions and results module (212).

The template database includes a number of templates. A specific template may be designed for the user's specific decision making role. For example, if the user is a chief information security officer, then the template may include questions relating to common objectives in the decision making process that relate to security and business objectives. The data elicited from the user is then placed into a preference elicitation database (224).

The various templates and questions used by the preference elicitation module may be created by an administrator. The administrator may have knowledge of common business and security objectives that are relevant to the roles of specific decision makers. The administrator grants access to the appropriate individual and manages the settings of the decision support system so that it operates in an efficient manner according to the needs of a particular organization.

The template may indicate a number of appropriate objectives. For each objective, a number of metrics may be used. Use of a particular metric for a given objective may be established by an administrator or elicited from a user. The metric provides the user with a mechanism for quantifying a particular objective. For example, breach prevention rate may be a metric for a security risk objective. The breach prevention rate metric gives the user a way to quantify how well various investments may affect the security risk objective.

The utility component selector module (208) includes the hardware and software for selecting the appropriate components of a utility function. The utility component selector guides the user, based on the template being used, through the elicitation process. This elicitation process may occur by means of a questionnaire with multiple choice options of strategic business and security objectives that are important to the decision maker. For example, in the case that the user is a chief information security officer, then the utility component selector may choose components such as breach rate, business loss, and investment costs. These components correspond to the objectives indicated by the user. In addition, the utility component selector module (208) guides a user through the identification of related metrics that would represent each identified objective. Although the template may provide an initial set of objectives, the user may add or remove objectives to fit his or her unique decision making responsibilities.

The preference value range module (210) includes the hardware and software for eliciting tolerance ranges or target levels of achievement for each of the objectives and metrics identified by the user. In addition, ratings of preferences between different objectives and investment decisions related to those objectives are elicited. There ratings include the user's preferences for which objectives are more important than others. For example, a user may indicate a range of investment costs that would be desirable, acceptable, or unacceptable. These different preferences may be used to weight the various components within the utility function.

The components of the utility function that are ultimately selected by the user can be placed into pairs based on a logical relationship between two objectives represented by the components. This can allow the user to see the relationship between two different objectives. This may allow the user to make better decisions when considering how making steps toward one objective will affect the other objective. For example, investments that result in a higher breach prevention rate may also result in a loss in the availability of an information service. Such a relationship may allow for the coupling of these two components. The user can then answer a number of questions generated by the questions and results module (212). These questions can be designed to determine which of the two components is more desirable.

A particular objective may not be exclusively coupled with another objective. For example, a cost objective can be coupled with a security objective in one instances and coupled with a business objective in another instance. Thus, the user may be provided with two graphs, one showing how a cost objective will affect a security objective and the other showing how the cost objective will affect the business objective. A third graph may also show how the security objective will affect the business objective.

The utility function builder module (216) includes the hardware and software for building a utility function based on the information elicited from a user by previous components. The utility function represents the user's preferences for a number of objectives. One example of a utility function is as follows:

U=w₁f₁(dB)+w₂f₂(dL)+w₃f₃(dC) Equation (1)

Where:

U=utility;

w=weight

f=function

dB=change in confidentiality required to reach target objective

dL=change in availability required to reach target objective; and

dC=change in investment costs to reach target objective

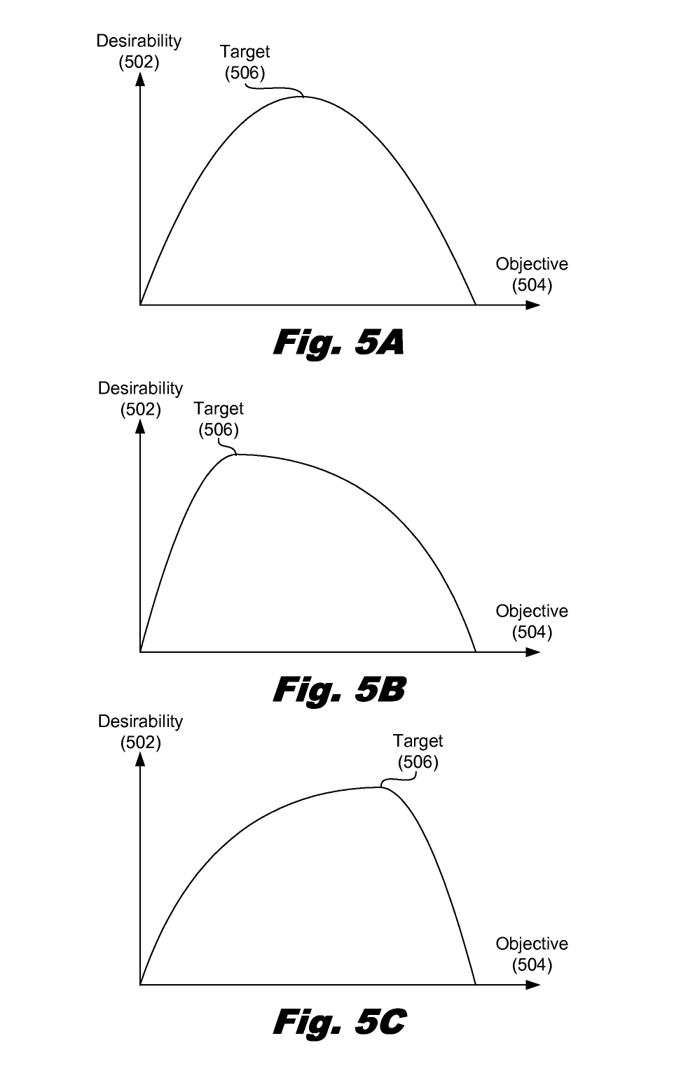

Equation 1 is a utility function that includes three components. In this example. In this example, the three different objectives are confidentiality, availability, and investment costs. Each of these functions may be weighted according to the user's preferences as to which objective is most important. The function (f) may be designed to best match the nature of how important it is to reach a target objective. More detail on the function will be described below in the text accompanying FIGS. 5A-5C.

The simulation module (220) includes the hardware and software for simulating the results of a number of potential investment options. In the case of information security, such investments may include additional hardware with various security features. Such investments may also include the implementation of new security policies. The simulation module simulates the implementation of each of the available investments or any combination thereof. These results are then provided to the preference mapper module (214).

In some cases, the simulation module (220) does not need to actually perform simulations. The expected outcome of a particular investment decision may be simple enough to not require a simulation. Alternatively, simulations may have been run on particular investment decisions in the past. The simulation module (220) may store a number of expected outcomes or results from past simulations and provided these results or expected outcomes to the decision support system when appropriate.

The preference mapper module (214) includes the hardware and software for mapping the results of the simulation to the utility function derived from information provided by the user. By mapping the results of the simulation to the utility function, the decision support system is able to determine which investment options correlate best with the user's preferred objectives. The investments that correlate best with the user's objectives may be presented to the user through the graphical user interface (202). This information may then be used by the user to aid in his or her decision making process.

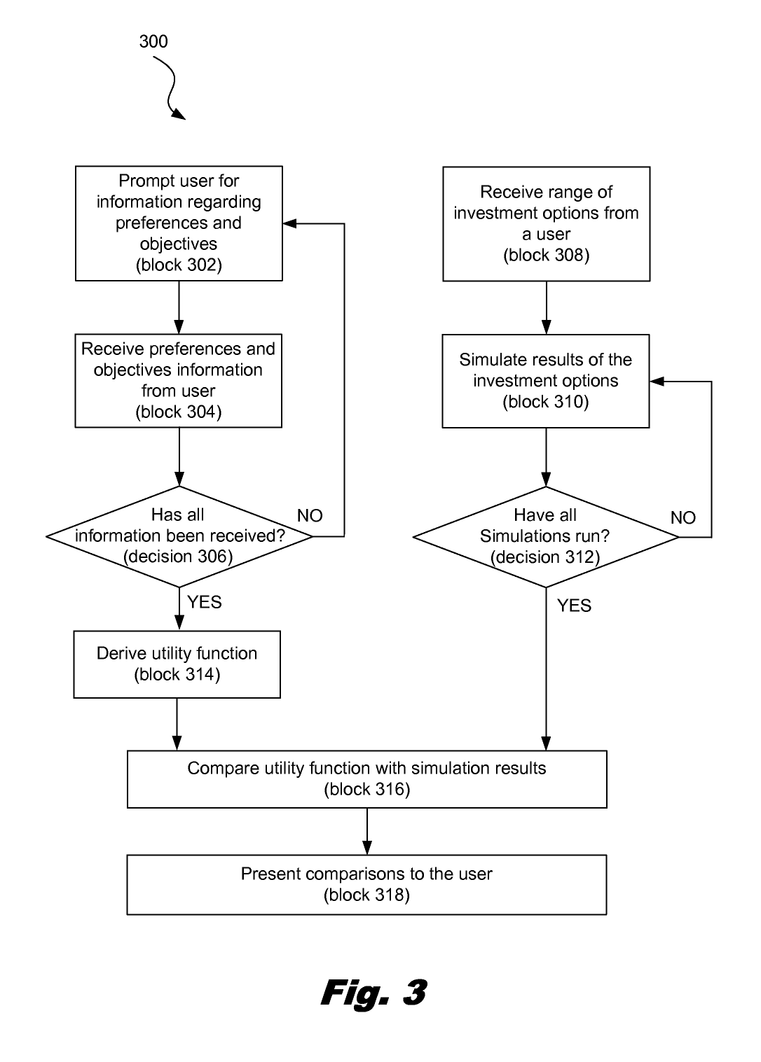

FIG. 3 is a flowchart showing an illustrative process (300) for decision support. According to certain illustrative examples, the process (300) starts when the decision support system prompts (block 302) a user for information relating to an organization's objectives. For example, the user may be a chief security officer who is responsible for protecting the organization's informational assets. The decision support system may elicit a variety of security objectives from the chief security officer. These objectives may be, for example, a minimum breach rate, a minimum business down-time, and minimum costs.

In some examples, the decision support system prompts the user for information by requesting that the user answer a series of questions. These questions may ask the user to rate different objectives by importance. Additionally, the user may answer specific questions about a particular objective. For example, the user may specify that he or she desires a breach prevention rate of at least 95%. The metric of breach prevention rate would affect the security objective. As mentioned above, these objectives may be paired. The user can then answer questions relating to which of the two pairs is more important.

After the decision support system receives (block 304) preferences and objectives information from the user, the system then determines (decision 306) whether or not all of the information requested has been received. If the information has not (decision 306, NO) been received, then the system prompts the user for the remaining information. If all of the information has indeed (decision 306, YES) been received, then the decision support system can derive (block 314) the utility function.

Beforehand, concurrently, or subsequently, a simulation module (e.g. 220, FIG. 2) of the decision support system receives (block 308) a range of investment options from a user. In the case of information security investments, the range of investment options may include various hardware devices such as routers with particular security features. Additionally, an investment may include various security policies to be implemented.

The simulation module will then simulate (block 310) the effects of the various investment options available. The decision support module will then determine whether (decision 312) all of the appropriate simulations have run. If all of the appropriate decisions have not (decision 312, NO) run, then the system will run the remaining simulations. If all of the appropriate decisions have run (decision 312, YES), then the decision support system can proceed to compare (block 316) the simulations results with the derived utility function.

The results from the simulation are then compared (block 316) with the derived utility function. The investment decisions or combinations of investment decisions that best match the utility function are then presented (318) to the user. Thus, the user is provided with a number of investment decisions which will best match his or her stated objectives.

The above described process illustrates one example of how the decision support system may operate. Other processes may be used. For example, the preference elicitation may be bidirectional. Thus, the user may go back to previously answered questions and revise his or her responses. This may be done at any time, even after the final utility function has been derived. Changes in a user's responses may result in a reformation of the utility function.

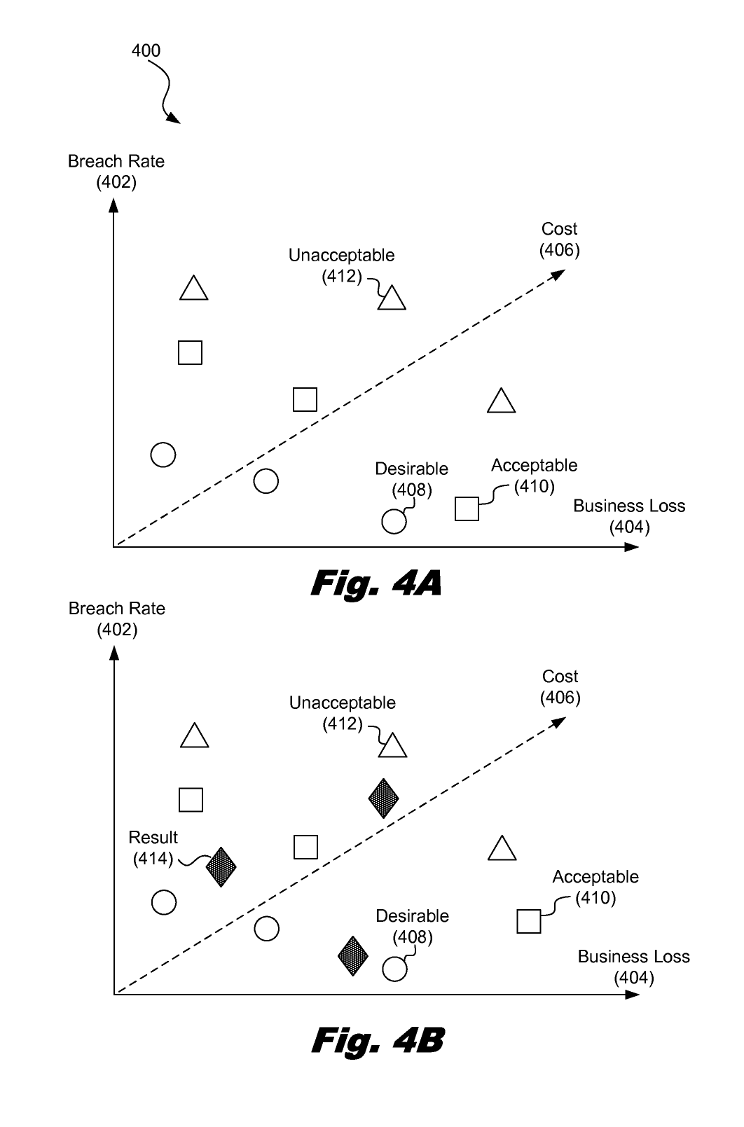

FIGS. 4A and 4B are graphs showing illustrative value pairs representing information received by a user. As mentioned above, two different objectives and thus utility function components can be paired. FIG. 4A is a graph that shows only the potential outcomes and FIG. 4B is a graph that includes the simulation results. The vertical axis represents breach rate (402). A placement close to the origin along the vertical axis indicates a low breach rate. The horizontal axis represents business loss (404). A placement closer to the origin along the horizontal axis represents a small amount of business loss. The diagonal line generally represents cost (406). In general, investments that result in a low breach rate and a small amount of business loss are more costly.

FIG. 4A illustrates a number of potential outcomes. The circles represent the desirable outcomes (408), the squares represent the acceptable outcomes (410) and the triangles represent the unacceptable outcomes (412). The placement of these outcomes is based on the derived utility function and information received by the user. In general, lower breach rates and a small amount of business loss are more desirable.

FIG. 4B illustrates the results of simulated investments. These simulation results are represented by the shaded diamonds. Each shaded diamond represents the results of a particular investment of combination of investments. For example, if one of the potential investment options is to implement a particular security policy, then the simulation results would include a simulated breach rate and a simulated business loss if that security policy were to be implemented. A user may then view a graphical representation as shown in FIG. 4B to determine which investment decisions would obtain the best results. In some cases, there may be more than one potential investment decision that will bring about acceptable or desirable results. The user may decide which of these investments to pursue based on other factors such as cost.

In some cases, the decision support system can indicate to the user which potential investment decisions best match the user's indicated preferences. In general, a simulation result that is graphically close to a desirable outcome indicates that the corresponding investment decision for that simulation result will actually result in the desired outcome. However, in some cases, the nature of a target outcome for a particular objective may affect how well a simulation result matches a desirable outcome. For example, a user may prefer to come short of achieving the target more than going beyond the target. Alternatively, a user may prefer to go beyond the target than to fall short of achieving the target. A target refers to the most desirable outcome for a particular objective within the bounds of realistic expectations. For example, a target breach rate may be 0.02%.

FIGS. 5A-5C are diagrams showing illustrative examples of the nature of target outcomes. The vertical axis refers to desirability (502) and the horizontal axis refers to a measurement of a particular objective. The peak of the curve indicates the target point (506) for the objective.

FIG. 5A illustrates the case where the user has indicated that exceeding the target or falling short of the target effect the desirability in the same manner. Such a function is referred to as a symmetric function. An example of such a function is a quadratic function. Thus, a utility component exhibiting this property may include a quadratic function.

FIG. 5B illustrates the case where the user has indicated that it is preferable to exceed the target (506) than to fall short of the target (506). Conversely, FIG. 5C illustrates the case where the user has indicated that it is preferable to fall short of the target than to exceed the target (506). Various functions can be used to represent these properties. These functions are referred to as asymmetric functions. An example of such an asymmetric function is f(x)=(e^{ax}−ax−1)/a², where a is an arbitrary constant.

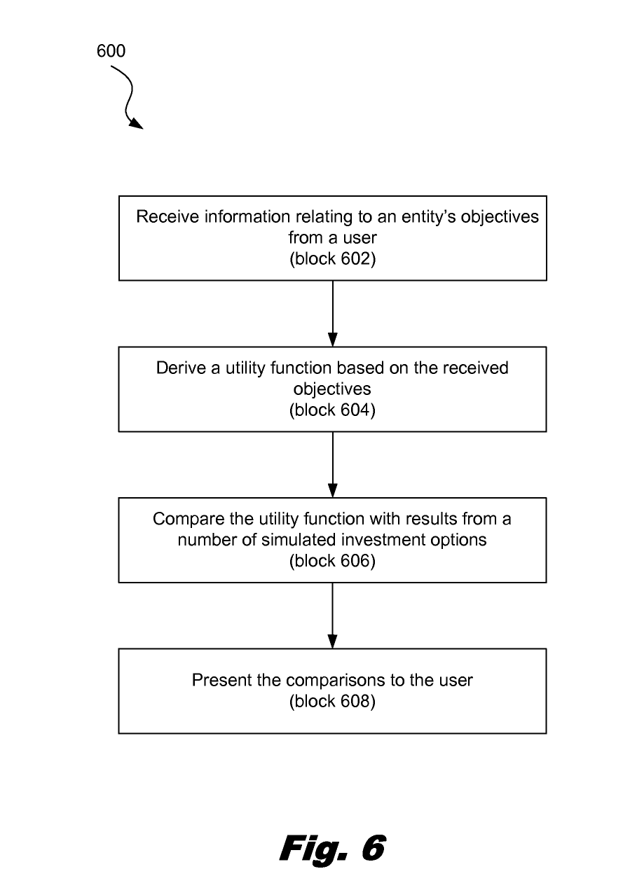

FIG. 6 is a flowchart showing an illustrative method for decision support. According to certain illustrative examples, the method (600) includes receiving (block 602) information relating to an entity's objectives from a user, deriving (block 604) a utility function based on the received objectives, comparing (block 606) the utility function with results from a number of simulated investment options, and presenting (block 608) the comparisons to the user.

In conclusion, through use of systems and methods embodying principles described herein, decision makers within an organization may be able to get more information related to potential investments. For example, a chief information security officer may obtain better information about how a potential security measure will fit in with the organization's risk tolerance for security breaches as well as their economic ability to take on such measures.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for decision support for information technology network security investments performed by a physical computing system, the method comprising:
with said physical computing system, deriving a utility function based on a number of objectives for an entity, said utility function reflecting relationships between said number of objectives;
with said physical computing system, comparing said utility function with results from a number of simulated investment options; and
with said physical computing system, causing said comparisons to be presented to a user associated with the entity.

2. The method of claim 1, in which said utility function balances at least three different objectives.

3. The method of claim 1, in which said utility function comprises a number of components, each of said components corresponding to an objective.

4. The method of claim 3, in which said components are weighted based on preferences received from said user.

5. The method of claim 3, in which one of said components of said utility function is one of: asymmetrical and quadratic.

6. The method of claim 1, in which presenting said comparisons to said user comprises providing a graphical representation to said user.

7. The method of claim 1, in which receiving said information is in response to prompting said user based on a template associated with said entity's objectives.

8. The method of claim 1, in which receiving said information comprises:
receiving a number of objectives;
receiving a number of metrics affecting at least one of said number of objectives;
receiving at least one of: tolerance ranges and target levels for at least one of said metrics; and
receiving ratings of preferences for said number of metrics.

9. A computing system comprising:
a processor; and
a memory communicatively coupled to said processor;
in which said processor is configured to:
derive a utility function based on a number of objectives for an entity, said utility function reflecting relationships between said number of objectives;
compare said utility function with results from a number of simulated network security investment options; and
cause said comparisons to be presented to a user associated with the entity.

10. The system of claim 9, in which said utility function balances at least three different objectives

11. The system of claim 9, in which said utility function comprises a number of components, each of said components corresponding to an objective.

12. The system of claim 11, in which said components are weighted based on preferences received from said user.

13. The system of claim 9, in which presenting said comparisons to said user comprises providing a graphical representation to said user.

14. The system of claim 9, in which receiving said information is in response to prompting said user based on a template associated with said entity's objectives.

15. A method for decision support for information technology network security investments performed by a physical computing system, the method comprising:
with said physical computing system, deriving a utility function based on a number of network security objectives and a number of business objectives for an entity, said utility function reflecting relationships between said number of security objectives and said number of business objectives;
with said physical computing system, comparing said utility function with results from a simulated network security investment option to determine how well said security investment option meets said objectives; and
with said physical computing system, causing said comparisons to be presented to a user associated with the entity;
in which metrics used to quantify said network security objectives and said business objectives represented by said utility function are customized for said entity.
